(19) United States
(12) Patent Application Publication
(10) Pub. No.: US 2009/0222415 A1
(43) Pub. Date: Sep. 3, 2009

(54) EVALUATING RISK OF INFORMATION MISMANAGEMENT IN COMPUTER STORAGE

(75) Inventors: Yasuyuki MIMATSU, Cupertino, CA (US); Michael Hay, Mountain View, CA (US); Keiko Harada, Forest Hills, NY (US)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 12/041,560

(22) Filed: Mar. 3, 2008

(51) Int. Cl. G06F 7/06; G06F 17/30

(52) U.S. Cl. 707/3; 707/1; 707/E17.014

(57) ABSTRACT

Method and system of evaluating overall risk of mismanagement of information contained in a file and its copies on a storage system. The method collects information about storage availability, accessibility, preservation and searchability of the data in each file. The method quantifies the collected information and allows a user to define risk criteria and assign risk values for each aspect of the collected information. The file risk of mismanagement of a specified data file is evaluated and compared against a threshold to determine whether or not the file is well-managed. If the file has copies, the file risk of mismanagement of each of the copies is also evaluated to obtain the risk of mismanagement of information in all of the copies. Copies with high risks of mismanagement may be discarded to lower the risk of mismanagement of the information. An administrator of a storage system may perform the method.

### BACKGROUND

1. Field of the Invention

The present invention relates generally to data storage in computer systems and, more particularly, to risk management in data storage.

2. Related Arts

There is a need for long term storage and archiving of data for regulatory compliance or in anticipation of legal action. For example, companies keep emails, files, check images, and the like in archive storage systems. Information technology (IT) departments are usually able to manage, migrate and retain readability of data for 15 years. In a survey conducted by the Storage Networking Industry Association, 80% of the respondents expressed a need to retain their information for over 50 years and 68% expressed a need to maintain their information for over 100 years. The results of this survey may be found in “Solving the coming archive crisis”, http://www.snia.org/education/tutorials/2007/spring/data-management/Solving-the-Coming-Archive-Crisis.pdf.

However, there are risks involved with preserving digital data for long periods of time. For example, data recorded on tape is likely to become unreadable after ten years due to degradation of tape media.

Data needs to be protected from modification or deletion due to user mistake or intentional illicit acts. Moreover, if the data exists in multiple copies or multiple files, all of the copies should be managed so that none of the files are unintentionally modified or deleted.

Also, data must be retrieved quickly from the storage systems when it is requested because if it takes years to search and retrieve requested data, that is almost same as loss of the data. Finally, data should be deleted when its retention period expires. When a user wishes to delete a certain document, all of the copies should be located and deleted. The risk of mismanagement of information includes all of above aspects.

### SUMMARY

The following summary of the invention is included to provide a basic understanding of some aspects and features of the invention. This summary is not an extensive overview of the invention, and as such it is not intended to particularly identify key or critical elements of the invention, or to delineate the scope of the invention. Its sole purpose is to present some concepts of the invention in a simplified form as a prelude to the more detailed description that is presented below.

In accordance with one aspect of the inventive methodology, there is provided a method for evaluating and displaying risk of information mismanagement in a computer storage system. The inventive method involves obtaining a location of a specified file stored on the storage system; searching for copies of the specified file in the storage system to obtain found copies; obtaining a file risk of mismanagement value for each of the found copies; and displaying the file risk of mismanagement values for each of the found copies.

In accordance with another aspect of the inventive methodology, there is provided a method for monitoring and managing a risk of mismanagement of information contained in files being stored in logical storage units of physical storage devices, the physical storage devices being coupled to a server. The inventive method involves: receiving a request; determining if the request is a device discovery request, a criteria management request, a data replication request, or a risk evaluation request; extracting device management information from a requested physical storage device and storing the device management information in a configuration table at the server, responsive to the device discovery request asking for the requested physical storage device; displaying first tables comprising a file value table, a risk criteria table, and an evaluation threshold table and updating values recorded in the first tables, responsive to a criteria management request; managing copies of a specified file, responsive to a data replication request; and evaluating an overall risk of mismanagement of information contained in the copies and displaying the overall risk of mismanagement of information responsive to a risk evaluation request.

In accordance with yet another aspect of the inventive methodology, there is provided a system for storing information and monitoring a risk of mismanagement of the information. The inventive system includes an administrator incorporating a central processing unit; a user interface; and a memory. The inventive system further includes a storage system coupled to the administrator through a network. The storage system is adapted for storing data files, some of the data files being a copy of another data file. The memory stores parameters for calculating a file risk of mismanagement of each of the data files and for calculating the risk of mismanagement of the information contained in a specified data file and all copies of the specified data file.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims. It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows an information storage and risk management system according to aspects of the invention.

FIG. 2 shows a device definition table according to aspects of the invention.

FIG. 3 shows a configuration table according to aspects of the invention.

FIG. 4 shows a copy list table according to aspects of the invention.

FIG. 5 shows a file value table according to aspects of the invention.

FIG. 6 shows a risk criteria table according to aspects of the invention.

FIG. 7 shows an evaluation threshold according to aspects of the invention.

FIG. 8 shows a device address table according to aspects of the invention.

FIG. 9 shows a method of managing risk according to aspects of the invention.

FIG. 10 shows a method of processing a device discovery request according to aspects of the invention.

FIG. 11 shows a method of processing a risk criteria management request according to aspects of the invention.

FIG. 12 shows a method of processing a data replication request according to aspects of the invention.

FIG. 13 shows a method of processing a risk evaluation request according to aspects of the invention.

FIG. 14 shows a method of risk calculation for a file according to aspects of the invention.

### DETAILED DESCRIPTION

Aspects of the present invention are directed to methods and systems for managing data in computer storage systems by evaluating risk of information mismanagement in digital archive systems and displaying the risk to a user.

Aspects of the invention provide a method for evaluating and quantifying a file risk of mismanagement for a data file based on several component risks and presenting the evaluated final file risk to a user of the archive system. The component risks include the risks against availability of storage systems, accessibility of data, state of data preservation and searchability of data within the storage system. When a file has several copies on the storage system, the file risk of mismanagement of each of the copies is evaluated to obtain an overall risk of mismanagement of the information contained all of the copies. The overall risk of mismanagement of information is presented to the user together with the file risk of mismanagement of each of the copies. Further, a value may be associated with each copy as a weighting factor for increasing or decreasing the calculated file risk of mismanagement. A threshold risk value may be assigned and compared to the weighted risk of mismanagement of a particular copy to obtain a file risk of mismanagement for that particular copy. Copies with high file risk of mismanagement may be deleted from the storage system to save the cost of data management and to lower the overall risk of mismanagement of information.

Aspects of the invention provide a system including a server or an administrator that is coupled to a storage system through a network. The administrator collects management information from each of the physical storage devices in the storage system and maintains tables including the collected information. The administrator also include tables containing risk criteria associated with features that may be found in a physical storage device or in logical storage units within the physical devices. The risk criteria may be modified by a user of the system. The administrator also includes tables that contain information regarding the location of all copies of a data file on the storage system. The administrator calculates a file risk of mismanagement value for a specified file. If there are multiple copies of the information, the administrator also evaluates the file risk of mismanagement associated with each of the copies and evaluates the overall risk of mismanagement of the information taking into account the presence of all of the copies. The specified file may be specified by the user and the risk of mismanagement is then presented to the user so that the user can determine whether or not the information is well-managed according to some management criteria. The user may decide to maintain or discard some of the copies based on their associated risk of mismanagement to save management costs.

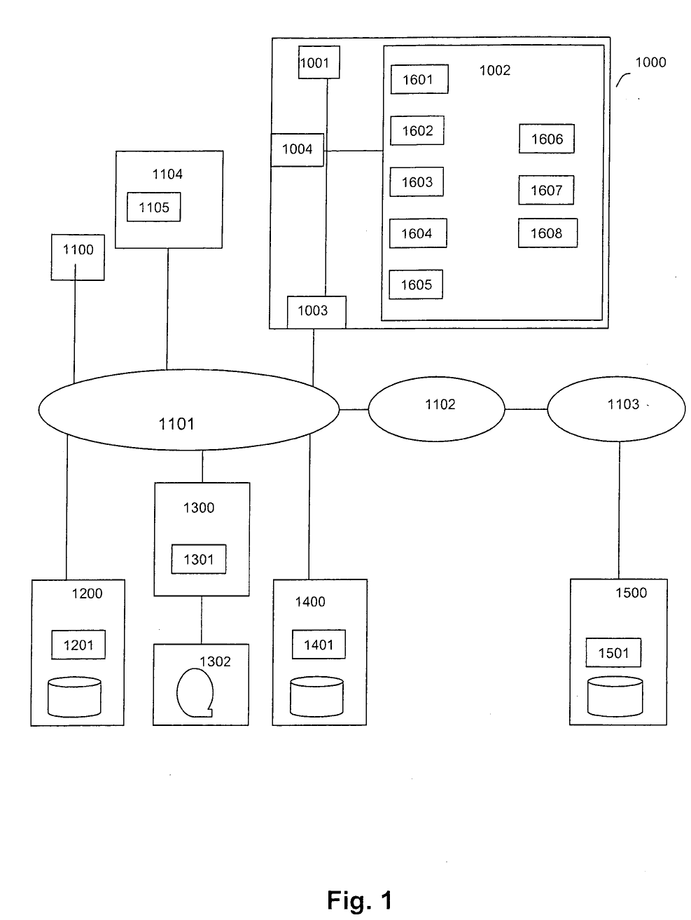

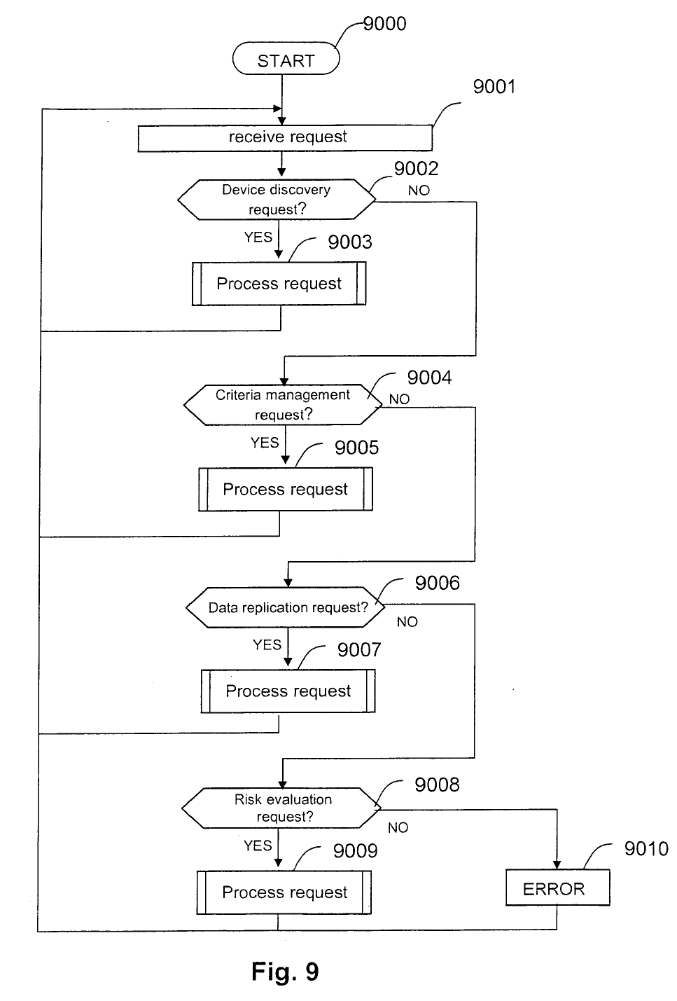

FIGS. 1 through 8 set forth a structure for a storage system according to aspects of the invention. FIGS. 9 through 14 set forth variations on a method of allocating risk to data storage according to aspects of the invention.

FIG. 1 shows an information storage and risk management system according to aspects of the invention.

The system of FIG. 1 includes an administrator and a storage system. The storage system includes physical storage devices and a search engine. The storage system stores data files, some of the data files being a copy of another data file. The administrator includes parameters for calculating a file risk of mismanagement associated with a specified data file and for calculating an overall risk of mismanagement of the information contained in all copies of the specified data file. All copies include the copy found at the address specified to the system and other copies of the file that may be automatically found by operation of the system. The administrator may be a server and includes a user interface for displaying the calculated risks to a user.

The system of FIG. 1 includes the administrator 1000, a client computer 1100, a search engine 1104, and several physical storage devices that are coupled together via local area networks (LAN) or wide area networks (WAN). The physical storage devices shown in the exemplary FIG. 1 include a network-attached storage (NAS) 1200, a tape access server 1300, and first and second content addressable storages (CAS) 1400, 1500. A tape library 1302 is shown as being coupled to the tape access server 1300. The networks shown for coupling the administrator 1000, the client 1100, and the search engine 1104 with the physical storage devices include first and second LANs 1101, 1103 and a WAN 1102.

The components shown are exemplary and the system of FIG. 1 may include fewer or more physical storage devices and other LAN or WAN connections as well as additional search engines or client computers.

The administrator 1000 includes a CPU 1001, a memory 1002, a LAN port 1003, and a user interface 1004. The memory 1002 includes a number of tables such as a management program 1601, a device definition table 1602, a configuration table 1603, a copy list table 1604, a file value table 1605, a risk criteria table 1606, an evaluation threshold table 1607, and a device address table 1608.

The tape access server 1300 includes management information 1301. The other physical storage devices, the NAS 1200 and the first and second CAS 1400, 1500, also include management information of their own 1201, 1401, 1501. The management information 1201, 1301, 1401, 1501 contain configuration of the corresponding physical storage device 1200, 1300, 1400, 1500, type of storage media used in the physical storage device, functions implemented to manage the data that is stored, and current state of the system regarding failures and loads.

In the exemplary storage system shown, the search engine 1104, the NAS 1200, the tape access server 1300, the CAS 1400, and the administrator 1000 are coupled together via the first LAN 1101. The first LAN 1101 is coupled to the second LAN 1103 through the WAN 1102. The second LAN 1103 is coupled to the second CAS 1500.

Further, in the exemplary system shown, the second LAN 1103 is coupled to the first LAN 1101 via the WAN 1102. The second CAS 1500 is a remote copy target for the CAS 1400. As such, the second CAS 1500 is coupled to the second LAN 1103 and paired with the first CAS 1400 to remotely replicate the data of the first CAS 1400.

During operation, the client computer 1100 creates and writes data and metadata in the physical storage devices including the NAS 1200 and the CAS 1400. The search engine 1104 includes management information 1105 which contains information about the ability of the search engine for indexing and search of the data in the physical storage devices as well as information about which regions of the physical storage devices are already indexed by the search engine. The search engine 1104 provides an index of specified data to allow the user to search the data. In one aspect of the invention, a search engine that does not use indexing may be included.

At the administrator 1000, the CPU 1001 executes the management program 1601 in the memory 1002 to communicate with a user of the administrator and with the physical storage devices 1200, 1300, 1400, 1500 and the search engine 1104. In the exemplary configuration shown, the administrator 1000 communicates with the user through the user interface 1004 and with the physical storage devices 1200, 1300, 1400, 1500 through the LAN port 1003. The management information 1105 of the search engine 1104 is accessed by the administrator 1000 via the first LAN 1101 and also through the LAN port 1003.

The management program 1601 evaluates the risk of mismanagement associated with the data stored in the physical storage devices and displays the risk to the user.

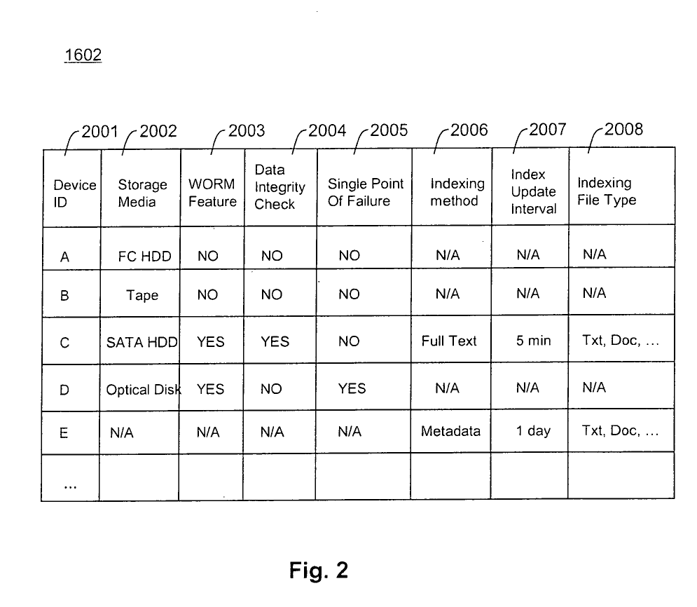

FIG. 2 shows a device definition table according to aspects of the invention.

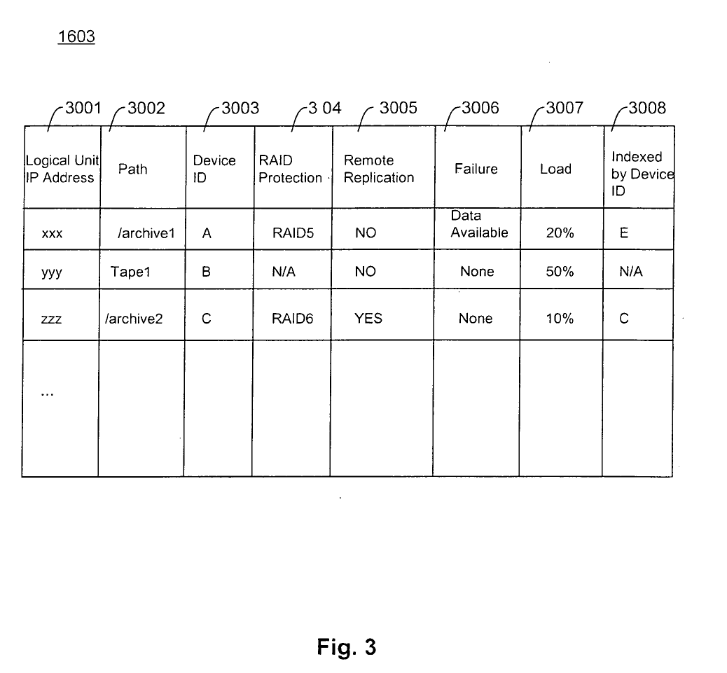

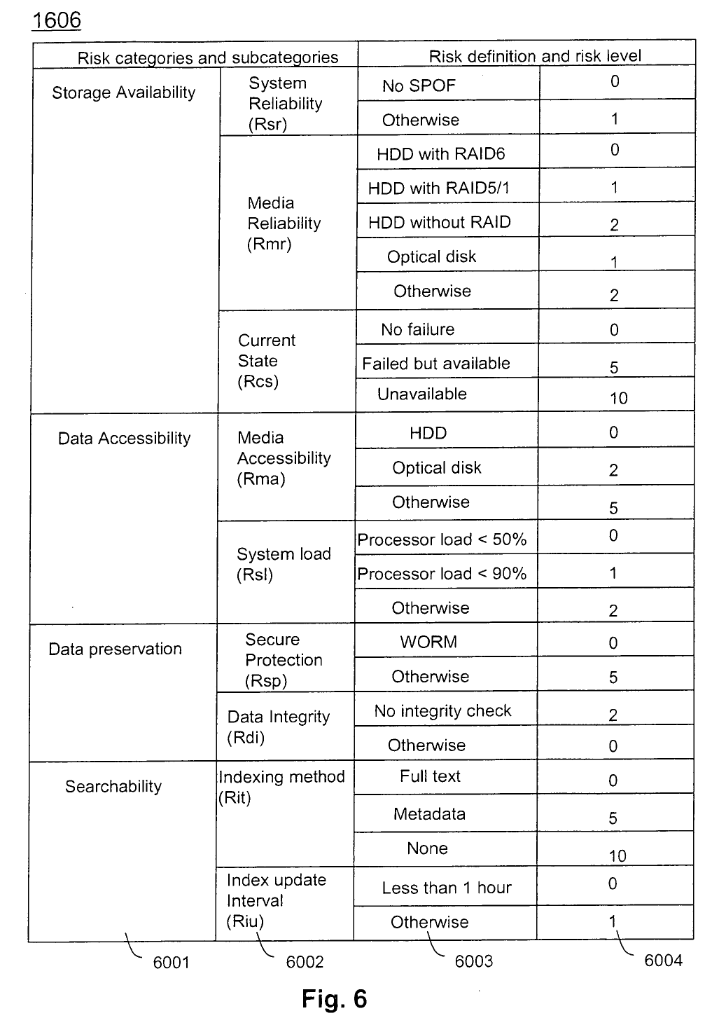

The device definition table includes device parameters and factors that influence the risk of mismanagement of data from a physical storage device. FIG. 3 includes some of the same information but is organized according to logical storage unit. A later FIG. 6 includes exemplary numerical values for the elemental risk levels assigned to the parameters listed in the device definition table of FIG. 2 and the configuration table of FIG. 3.

The device definition table shown in FIG. 2 is one exemplary embodiment of the device definition table 1602 shown as part of the memory of the administrator 1000 of FIG. 1. Further, the device definition table includes some of the same management information 1105, 1201, 1301, 1401, 1501, that is associated with each of the storage systems including the search engine 1104 or the physical storage devices 1200, 1300, 1400, 1500.

For each physical storage device which can be connected to the first LAN 1101, the device definition table 1602 contains a device identification 2001, a type of storage media 2002 which is used in the storage system, an indication 2003 of whether or not a write once read many times (WORM) feature is provided, a data integrity check 2004, a single point of failure (SPOF) indicator 2005, type of indexing method 2006 provided by the storage system, interval to update index 2007, and file types 2008 which can be indexed by the storage system. This table is predefined based on the specification of each physical storage device and the search engine.

The device identification 2001 provides a unique identifier for each physical storage device such as 1200, 1300, 1400, 1500 or the search engine 1104 of FIG. 1.

The type of storage media 2002 may be hard disk drive (HDD), fiber channel HDD (FC HDD), tape, serial ATA HDD (SATA HDD), optical disk, or the like.

The WORM feature 2003 indicates whether the storage system does or does not include a WORM capability. The WORM capability protects the data by preventing the data from being altered.

The data integrity check 2004 provides an indication of whether or not data integrity check is performed to detect degradation of data. For example, the storage system may generate a hash value for each data and verify the integrity of data based on the hashed value.

The SPOF indicator 2005 indicates whether a single point of failure exists in the storage system. When the value is YES and a single point of failure exists, if one component fails all of the system fails as a whole. If the value is NO, the system remains functional even if one component fails because all of the components are duplicated. An important design technique is redundancy. Redundancy avoids having a SPOF. If one part of the system fails, there is an alternate success path, such as a backup system. For example, a disk system configured in a redundant array of inexpensive drives (RAID) does not contain a single point of failure because if one of the drives fails, a copy of the same data is still available in the other drive (RAID1), or the copy of the data in the failed drive may be restored from parity information and data stored in other drives (RAID3, RAID4, RAID5 and RAID6). For example, in RAID1 configuration, all of the drives in the array must fail for the data to be lost. The RAID5 configuration, which is the most widely used, protects the storage system against data loss when one of the storage drives fails. In RAID5, the data loss can occur only when two or more drive fail at the same time. A RAID6 configuration, which incorporates double parity information, is even more reliable than RAID5 because for data loss to occur, an even larger number of drives (three or more) have to fail together.

The indexing method 2006 indicates whether the storage system provides full text search capability, only search by metadata or no search capability at all.

The index update interval 2007 indicates how often the index is updated. A system that is updated more frequently and with a smaller interval in between two updates can provide more precise search result.

The indexing file type 2008 includes the types of files that can be indexed in the storage system or search engine. For example, text file and Doc type files are capable of being indexed in the storage systems C and search engine E.

FIG. 3 shows a configuration table according to aspects of the invention.

For each logical storage unit, the configuration table includes a row of information. Examples of logical storage units include a file system, an optical disk platter, or a tape cartridge that is included in a physical storage device or in another type of storage system.

The configuration table shown in FIG. 3 is one exemplary embodiment of the configuration table 1603 of FIG. 1. For each logical storage unit, the configuration table 1603 contains an IP address 3001 used to access the logical storage unit, a path 3002 to identify the logical storage unit, an ID of a device 3003 which provides the logical storage unit, a type of RAID protection 3004 for the logical storage unit, whether or not the content of the logical storage unit is remotely replicated 3005 to protect the content against local disaster, whether or not there is a failure 3006 which may affect the logical storage unit, load 3007 of the storage device, and ID 3008 of the search engine or storage device which indexes the content of the logical storage unit. A value in Failure 3006 can be ‘None’ which means there is no failure, ‘Data Available’ which means there is some failure but data in the logical unit can be accessed, etc. Load can be evaluated by, for example, the processor utilization in the storage device, processed I/Os per second, amount of transferred data per second, average of response time, and so on.

For example, the first row of table 1603 indicates that the logical storage unit may be found at the IP address of xxx at path/archive1 in the physical storage device with a device ID of A. The logical storage unit is configured as RAID5 and it is not replicated at a remote location. Currently, there is some failure of the logical storage unit, but data in the logical storage unit is available. The logical storage consumes 20% of processing resources and is indexed by a search engine with the device ID of E.

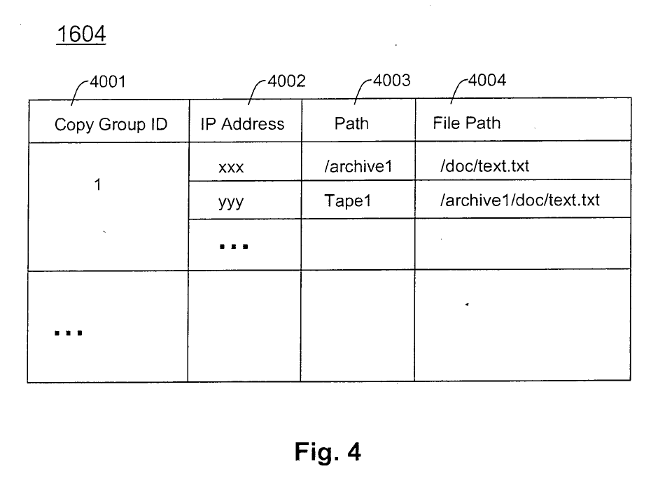

FIG. 4 shows a copy list table according to aspects of the invention.

A data file may have several copies that are each stored at a different location within the storage system. A copy group includes a data file and its copies. The copy list table helps keep track of the locations of the location of the files within copy groups. When source data is copied into destination data, the copy list table contains the IP address and path information of the source and destination data. For example, the information in the copy group with ID of 1 is copied into multiple logical storage units with IP addresses including xxx and yyy.

The copy list table shown in FIG. 4 is one exemplary embodiment of the copy list table 1604 of FIG. 1. For each piece of information which is copied to multiple files, the copy list table 1604 contains a copy group ID 4001 and information about the copies within each copy group. The information about the copies includes, for each copy, an IP address 4002 of the logical storage unit that contains the copy, a path 4003 to the logical storage unit in which the copy is stored, and a file path 4004 to identify the copy in the storage unit.

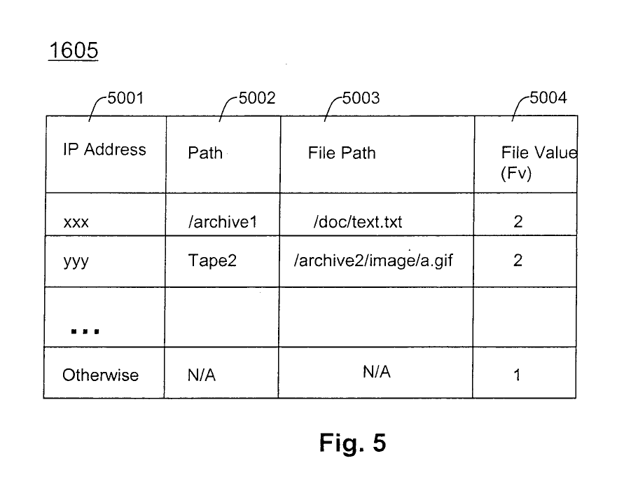

FIG. 5 shows a file value table according to aspects of the invention.

The file value table defines a file value or Fv for each data file. The file value, Fv, is represented by a number for each file and indicates the importance of the file. A higher number indicates a data file of a higher value whose risk of loss is weighted more heavily. Also, a file have a high number of Fv if it must be surely deleted at specified time because it contains, for example, confidential information. A lower number indicate a data file whose loss is not as important to the system. The file value is defined and assigned by the administrator for each file. The file value may be different for different copies of the same file. For example, one of the copies may be a cache copy that need not be preserved and has a low value while another copy must be preserved as the original copy and will be assigned a higher file value.

The file value table shown in FIG. 5 is one exemplary embodiment of the file value table 1605 of FIG. 1. Each data file is identified by an IP address 5001 of the logical storage unit including the file, a path 5002 of the logical storage unit in which the file is stored, and a file path to identify the file within the storage unit 5003. The file value Fv 5004 is provided for each copy of a data file.

FIG. 6 shows a risk criteria table according to aspects of the invention.

The risk criteria table defines a level of risk corresponding to each state or configuration of the storage system or data files stored on the storage system. The values shown in the table may be referred to as elemental risks. A component risk refers to a risk calculated when considering a number of related elemental risks. A file risk is associated with a data file and may be calculated for the data file using the calculated component risks or directly from the elemental risks defined in the risk criteria table.

Smaller numbers mean lower risk. For example, the Rsr is low (0) if there is no single point of failure (SPOF) in the storage system which contains a file. This is due to the fact that without a SPOF, the file is not likely to be lost or become unavailable due to a failure in the storage system. Otherwise, the risk associated with system reliability is shown as 1. The risk levels 0 and 1 are relative values that are defined by the administrator 1000 and do not indicate probabilities of 0% and 100%.

The risk criteria table shown in FIG. 6 is one exemplary embodiment of the risk criteria table 1606 of FIG. 1. A detailed description of table 1606 of FIG. 6 follows. However, the risk categories 6001, subcategories 6002, definitions 6003 and elemental risk levels 6004 that are shown are exemplary and may be modified and include more or fewer divisions.

The risk criteria table 1606 defines the risks associated with four risk categories 6001 of storage availability, data accessibility, data preservation, and data searchability.

The storage availability is in turn divided into three risk subcategories 6002 of system reliability (Rsr), media reliability (Rmr), and current state or health of the storage system (Rcs).

System reliability pertains to all components of the storage system such as a controller or connections to the servers. Two risk definitions 6003 are provided for the system reliability subcategory that include having no SPOF and otherwise. A system having no SPOF has a higher reliability and is assigned a risk level of 0. A system categorized as otherwise is assigned a risk level of 1.

Media reliability pertains to reliability of storage medium which contains the data. Current state indicates the current state of the data in the system. The media reliability subcategory is divided into five risk definitions of HDD with RAID6, HDD with RAID5/1, HDD with RAID, optical disk and otherwise. The risk levels assigned to these risk definitions are respectively 0, 1, 2, 1 and 2. These risk levels indicate that a HDD with RAID6 is considered as the most reliable media and is assigned a low risk level of 0 while a HDD without RAID and any system other than those included in the risk definitions 6003, are assigned the higher risk level of 2. A HDD with RAID5/1 is considered to be equivalent to an optical disk in media reliability.

The current state subcategory indicates the availability state of data and includes three risk definitions 6003 of no system failure, a failed system where the data was not lost and is still available, and a system where data is unavailable. The risk level 6004 associated with no system failure is 0, the risk level associated with data that is still available after a failure is 5 and the risk level of an unavailable data is assigned as 10 in the exemplary table shown.

The data accessibility is divided into two subcategories 6002 of media accessibility (Rma) and system load (Rsl).

Media accessibility indicates how quickly data can be retrieved from a medium. The media accessibility of a system depends on the storage media. It is divided into three risk definitions 6003 of HDD, optical disk and otherwise. HDD has a risk level of 0 indicating rapid retrieval speed. Optical disk is assigned a risk level of 2 indicating a less rapid retrieval speed. All other types of storage media are assigned the higher risk level of 5 indicating a rather slow data retrieval speed compared to the HDD and optical disk media.

System load indicates how busy a storage system is. At a busy system, data retrieval is delayed. Three risk definitions 6003 are provided corresponding to the system load including a processor load of less than 50%, a processor load of less than 90% and otherwise. When the processor load is at the smallest defined level, the risk level 6004 is defined at 0. As the processor load increases, data accessibility is reduced and risk of retrieval increases. So, when the processor is even busier than 90% of processor load, the risk level is increased to 2.

The data preservation is divided into two subcategories 6002 of secure protection (Rsp) and data integrity (Rdi). Each subcategory 6002 is divided into two risk definition groups 6003 and assigned two different risk levels 6004. The secure protection subcategory has two risk definitions of including WORM protection and having a risk level of 0, or not including this type of protection and having a risk level of 5. The data integrity subcategory includes two risk definitions of having no integrity check corresponding to a risk level of 2 and including some type of integrity check with a risk level of 0.

The data searchability is divided into two subcategories 6002 of type of indexing method applied to the file (Rit) and an interval to update index (Riu). Three indexing methods of full text, metadata, and none are defined with corresponding risk levels of 0, 5 and 10. Therefore, a full text indexing is the best type of indexing that yields the highest searchability with the lowest risk. Two index update intervals of updating more frequently than every hour and otherwise are defined with corresponding risks of 0 and 1 respectively. If the index is updated more frequently, the searchability is higher and the risk level associated with mismanagement of data due to not finding the data in a search is lower. On the other hand, the type of indexing has a larger impact on searchability of the indexed data than the update frequency of the index.

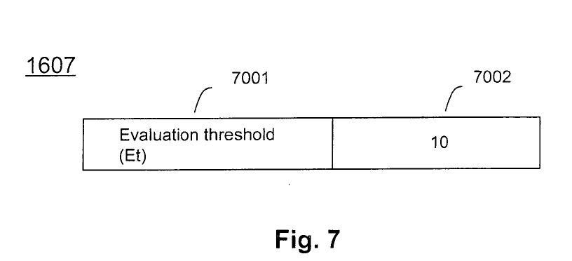

FIG. 7 shows an evaluation threshold according to aspects of the invention.

The evaluation threshold, Et, is used for risk evaluation as a standard level for well-managed information. If the risk level calculated for a data file or the overall risk of mismanagement of information in all copies of the data file is higher than the assigned evaluation threshold Et, then the information contained in the component or the storage system is at risk of being lost.

The evaluation threshold shown in FIG. 7 is one exemplary embodiment of the evaluation threshold 1607 of FIG. 1. In FIG. 7, the evaluation threshold 7001 is given a value 7002 of 10.

As seen below, the evaluation threshold value 7002 is used in the risk calculation for a data file by subtracting this value 7002 from a calculated risk. As such, the resulting file risk may be negative if the evaluation threshold value 7002 is larger than the calculated risk. A negative file risk indicates a low risk of mismanagement and secure storage of the data file.

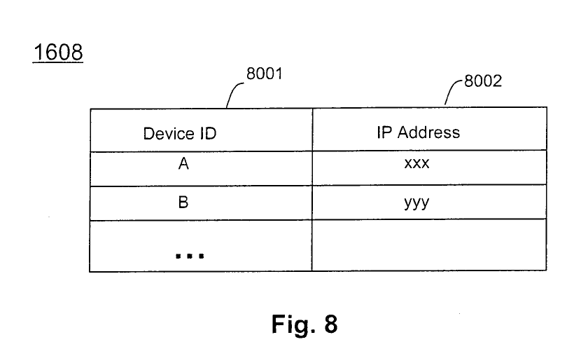

FIG. 8 shows a device address table according to aspects of the invention.

The device address table shown in FIG. 8 is one exemplary embodiment of the device address table 1608 of FIG. 1. For each storage system or search engine which is managed by the administrator 1000, the device address table 1608 contains a device ID 8001 and an IP address 8002. The device address table 1608 includes all physical storage devices and search engines that exist in the system and managed by the administrator 1000 irrespective of the logical storage units that contain the data of interest.

FIG. 9 shows a method of managing risk according to aspects of the invention.

The method of managing risk of FIG. 9 may respond to and process different types of requests related to risk evaluation and management. The method of managing risk begins at 9000. At 9001 a request is received from a user. In one aspect of the invention, four types of requests may be received that include a device discovery request 9002, a criteria management request 9004, a data replication request 9006, and a risk evaluation request 9009. In this aspect of the invention, other requests result in an error 9010 in the method. In other aspects of the invention, further requests may be considered as appropriate requests for processing by the system.

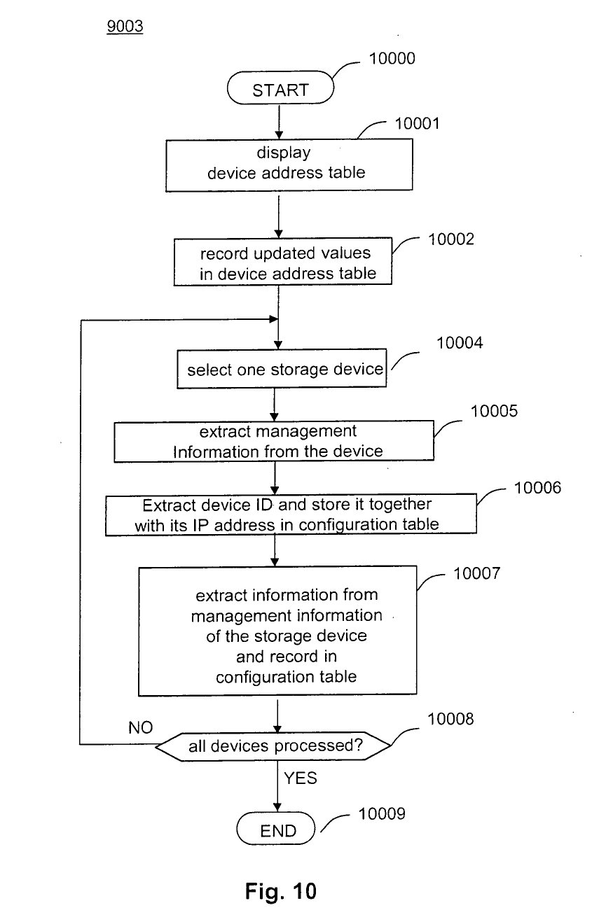

After the process determines the receiving of each request, the received request is processed 9003, 9005, 9007, 9009. Methods of processing each of these requests are shown and described in further detail in FIGS. 10, 11, 12, and 13.

In one aspect of the invention, the method of managing risk whose flow chart is shown in FIG. 9 may be performed by the management program 1601 of FIG. 1. The request may be received via the user interface 1004 of FIG. 1.

FIG. 10 shows a method of processing a device discovery request according to aspects of the invention.

In response to a device discovery request, an address for the device is located in the device address table and its management information are retrieved from the device. The management information is used to populate the configuration table in a row corresponding to the address of the device.

Processing of the device discovery request 9003 begins at 10000. At 10001, the method displays the content of a device address table in a user interface to allow the user to edit the values in the device address table. At 10002, the ID and/or IP addresses of the devices specified by the user are update in the device address table.

At 10004 through 10008, the method reads the management information stored in the particular storage device and extracts information to be stored in the configuration table.

At 10004, one storage device or search engine is selected from the device address table. At 10005, a request is sent to the specified IP address of the selected device in order to read the management information stored in the device. The request can be sent by using a standard protocol like SMI-S or SNMP, or by a proprietary protocol which is identified by the device ID specified by the user. At 10006, a device ID corresponding to the IP address is extracted from the management information of the storage device and stored in the configuration table. At 10007, for each logical storage unit in the storage device, information about system configuration, failures, system load, and indexing capability is extracted and stored in the configuration table. At 10008, the method determines whether all of the devices in the device discovery request have been processed.

If all the devices have been processed, then the processing of the device discovery request ends 10009.

In one aspect, the method of FIG. 10 is implemented by the system of FIG. 1. Through a device discovery request, a user specifies the physical storage devices to be managed by the administrator 1000. The storage devices may be the NAS 1200, the tape access library 1300, the first CAS 1400, the second CAS 1500, the search engine 1104 or other storage devices coupled to the administrator 1000. The user interface used for displaying the data to a user may be the user interface 1004 of FIG. 1.

In this aspect of the invention, the user instructs the management program 1601 to collect management information pertaining to the specified devices. The management program 1601 displays the content of the device address table 1608 to the user in the user interface 1004 in order to allow the user to edit the values in the table 1608. The device address table 1608 may be used to find the IP address 8001 of a device and this IP address may be used to locate the device. The management program selects one specified storage device from the device address table 1608. Then, the management program 1601 sends a request to the specified storage device, for example the first CAS 1400, to read the management information 1401 stored in the first CAS 1400. Then, the management program 1601 extracts the device ID from the management information 1401 of the first CAS 1400 and stores it as device ID 3003 in the configuration table 1603. Then, the management program 1601 extracts the system configuration information, failure information and system load information from the management information 1401 of the first CAS 1400 and stores it in the configuration table 1603. The system configuration information includes the IP address 3001 and the path 3002 of the logical storage unit, the RAID protection level 3004, and the information about remote replication 3005 for each logical storage unit like file system, optical disk, tape cartridge. Information about failures 3006 includes what kind of failures exist currently in the device. The system load information 3007 includes the current load of the device. When the files of a logical storage unit are indexed by a search engine, the ID of the search engine is recorded in column 3008 of the row corresponding to the logical storage unit in the configuration table 1603. Last, the management program 1601 determines whether all of the devices in the device discovery request have been processed. If all the devices have been processed, then the processing of the device discovery request ends 10009. For each device that is processed, a row is added to the configuration table 1603.

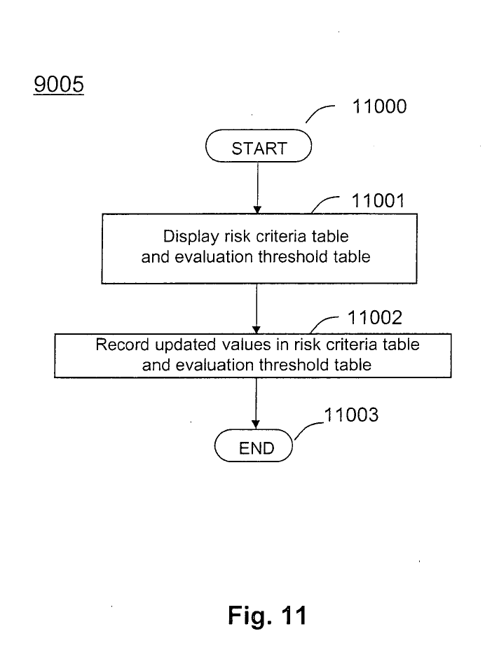

FIG. 11 shows a method of processing a risk criteria management request according to aspects of the invention.

FIG. 11 shows one exemplary method for processing of the risk criteria management request 9005 of FIG. 9. The processing of the request begins at 11000. At 11001, the contents of a risk criteria table and an evaluation threshold are displayed to a user to allow the user to edit the contents of these tables and update the values. At 11002, the updated values are stored in the risk criteria table and/or the evaluation threshold table. The processing of the risk criteria management request ends at 11003.

The risk criteria table 1606 and the evaluation threshold 1607 may be displayed to the user and the updated values may be stored in the risk criteria table 1606 and/or the evaluation threshold table 1607.

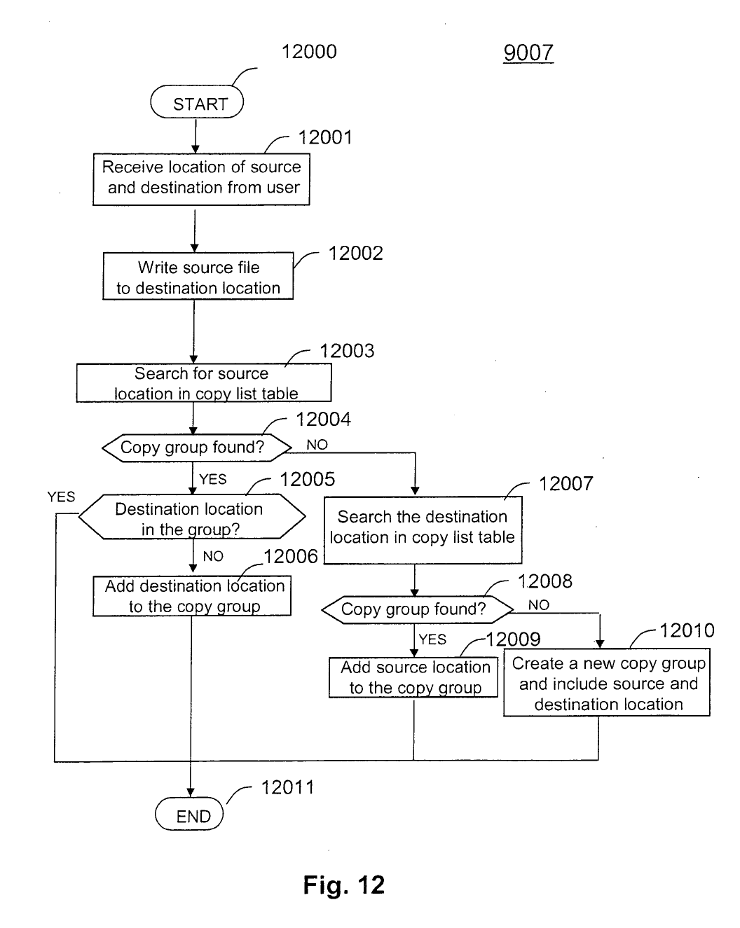

FIG. 12 shows a flow chart of data replication request according to aspects of the invention.

The process of FIG. 12 tracks the relationship among the copies of each data file and records the number and paths of the copies for each data file.

FIG. 12 shows one exemplary method for processing the data replication request 9007 of FIG. 9. The processing of the request begins at 12000. Through the data replication request, a user can replicate a data file. The relationship among the copies made of the file is recorded in the administrator 1000 and used to evaluate an overall risk of mismanagement of the information which has multiple copies.

At 12001, the location of a file to be copied (source data) and the location of a file to be created as a copy (destination data) are received, for example, by the management program 1601 from the user through the user interface 1004. Each location can be specified by an IP address and path of a storage unit which contains the file and the file path which identifies the file within the storage unit.

At 12002, the management program 1601 reads the source file according to the source data and writes the destination file according to the destination data.

At 12003 through 12010, the management program 1601 records the information about the relationship among the copies in the copy list table 1604. At 12003, the management program 1601 searches the copy group 4001 which includes the location of the source files in the copy list table 1604.

At 12004, the management program 1601 determines whether a copy group is found that includes the source location. If a copy group 4001 including the source location is found then at 12005, the management program determines whether or not the destination location is also included in the copy group. If the destination location is included in the copy group, then the relationship between the source location and the destination location is already recorded in the copy list table and the process ends at 12011. Otherwise, and if the destination location is not included in the copy group, then at 12006, the management program adds the location of the destination file to the copy group and the process then ends at 12011.

If at 12004, no record is found for the source location in the copy list table, then at 12007 the management program searches the destination location in the copy list table. At 12008, if the management program finds a copy group which includes the destination location as its member, then at 12009 the management program adds the source location as a member of the group in the copy list table. Otherwise, at 12010, the management program creates a new group and records the source and destination location as members of the new group.

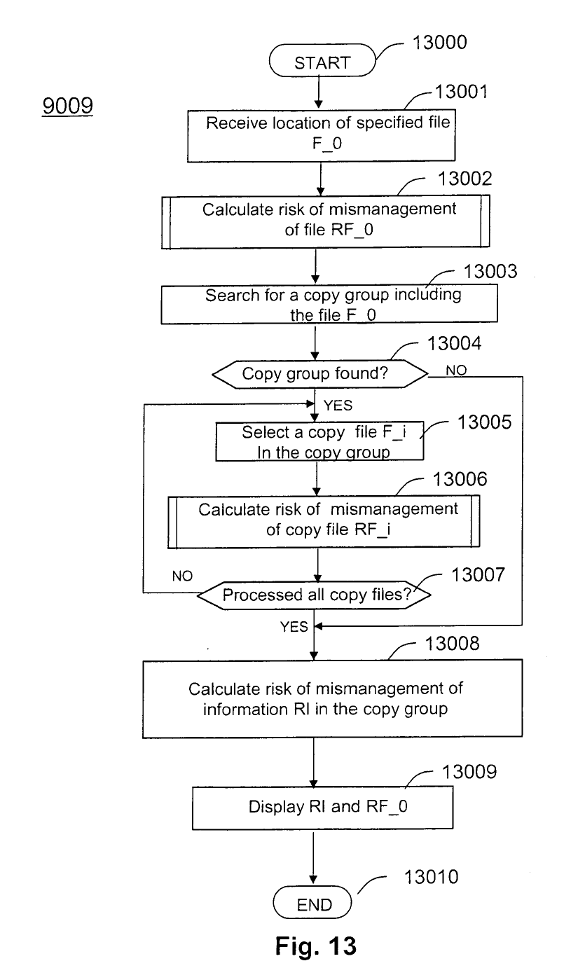

FIG. 13 shows a flow chart of a risk evaluation request according to aspects of the invention.

By the process shown in this figure, a user can evaluate the various risks associated with various aspects of a file, the information contained in the file and the copies of the file.

FIG. 13 shows one exemplary method for processing the risk evaluation request 9009 of FIG. 9. The risk evaluation process 9009 begins at 13000. At 13001, the management program 1601 receives the location of a specified file, such as a file F_0, whose risk of mismanagement RF_0 is to be evaluated. At 13002, the management program calculates the various component risks associated with the specified file F_0 to obtain a file risk of mismanagement RF_0 for the specified file. The detail of the calculation is described later.

At 13003, the management program searches a copy group which contains the specified file F_0 in the copy list table. At 13004, the management program determines whether such copy group is found. If no copy group including the specified file is found, the file has no copy and the management program does not have to be calculates the risk of copies. If a copy group including the specified file is found, then at 13005 the management program calculates risks RF_i associated with each copy F_i. If there are n copies of a specified file, the management program calculates RF_1, RF_2 . . . RF_n at 13005 through 13007. At 13005, one copy F_i in the group of n copies is selected. At 13006, the risk RF_i is calculated. At 13007, it is determined whether all of the n copies of the file F_0 have been processed and the loop repeats if not all of the copies have been evaluated for the various risks associated with each specified file.

At 13008, the risk associated with the mismanagement of information contained in specified file and its copies, RI, is calculated as a sum of the risks associated with the specified file and the risk associated with each copy of the file according to the equation below:

RI=RF_{—}0+RF_{—}1+ . . . +RF_{—}n

While redundancy and having copies in general reduces the risk, the overall risk of mismanagement of information RI is still calculated as a sum because some of the risks in the sum may be negative. The benefits of having multiple copies in reducing the risk of mismanagement are demonstrated through having negative risk values for some of the RF_i. Further, redundancy while beneficial in most cases may still be costly. Aspects of the invention permit a copy file that carries a large risk of mismanagement to be identified and eliminated to save the cost of storing this copy.

If a file is well-managed and has a low risk, RF_i becomes low and may be negative. In this case, the file is a ‘good’ copy which contributes to reduce the risk of archiving the information. On the other hand, if a file is at risk, RF_i becomes a large positive number. Such a copy does not reduce the risk and should be eliminated because it increases management costs by adding to the number of files. Finally, at 13009, the management program displays the risk associated with the specified file RF_0 and the risk associated with the information contained in the specified file together with its copies, RI, as that is obtained from the risk evaluation process. The risk evaluation process ends at 13010.

Calculation of the risk associated with one file is further explained below. This may be the calculation of the risk RF_0 associated with specified file F_0 at 13002 or calculation of the risk RF_i associated with a selected copy F′_i of the specified file at 13006.

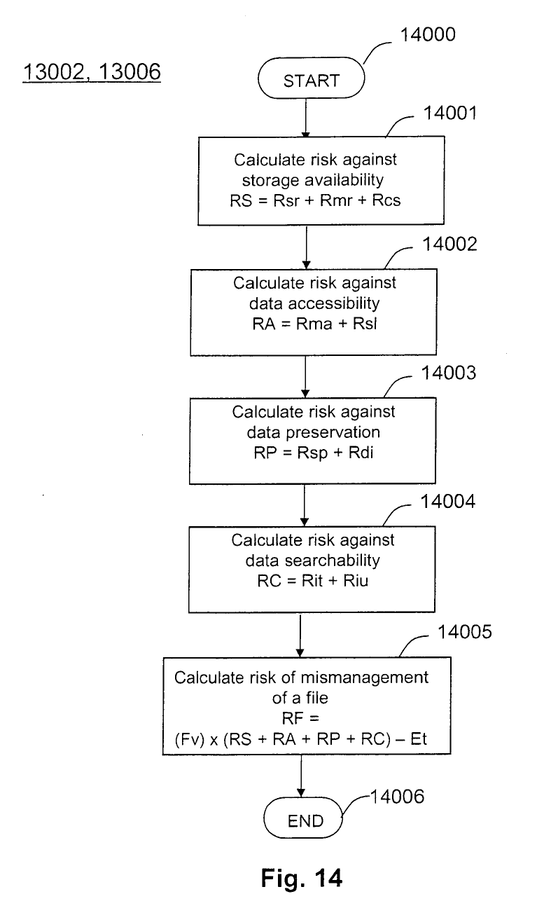

FIG. 14 shows a flow chart of risk calculation for a file according to aspects of the invention.

The risk calculation process for a file, whether it is a specified file such as F_0 or one of the copies F_i, is shown in FIG. 14. While different notations are used for the sake of description, a specified file and its copies are processed in the same way by the risk calculation process. At 14001 through 14004, the management program calculates a risk associated with storage availability (RS), a risk associated with data accessibility (RA), a risk associated with data preservation (RP), and a risk associated with data searchability (RC) by adding the elemental risk levels defined for each component in a risk criteria table such as the risk criteria table 1606 of FIG. 6. Equations corresponding to each calculation are shown below:

RS=Rsr+Rmr+Rcs

RA=Rma+Rsl

RP=Rsp+Rdi

RC=Rit+Riu

For a specified file, such the file F_0 that is specified and requested by the user, the management program identifies the storage unit which contains this file by matching the IP address 3001 of the file with the file path 3002 of the file and the path in a configuration table such as the configuration table 1603 of FIG. 3. Also, the specification of the storage device can be identified by matching device ID in the device definition table. With these pieces of information, the management program selects the risk level corresponding to each of the Rsr, Rmr, Rcs, Rma, Rsl, Rwp, Ric, Rif, and Riu that are specified in the risk criteria table. In step 14005, the management program calculates the file risk of mismanagement RF, associated with a file F_0 or any copies of this file F_i, by the equation below:

RF=(Fv)×(RS+RA+RP+RC)−Et

Where Fv is the value of the file and Et is the evaluation threshold value. The file value Fv is used as a weight factor. If the file value Fv of the file is large, the file risk of mismanagement RF will also likely be large unless the file is well-managed. If the (Fv)×(RS+RA+RP+RC) is less than the evaluation threshold Et, then the file risk of mismanagement RF becomes negative and it contributes to decreasing the risk associated with the mismanagement of the information.

By these processes, an overall risk of mismanagement of the information can be evaluated based on availability of storage systems, accessibility of data, state of data preservation and searchability.

For example, if the exemplary values listed in the risk criteria table 1606 are used, for a specified file or a copy of the specified file, the file risk of mismanagement for the file or the copy is calculated as follows.

The exemplary file is stored on a storage system with no SPOF, on an optical disk where some failure has occurred in data storage but the data is still available.

RS=Rsr+Rmr+Rcs=0+1+5=6

The storage system is not so busy because only the half of processing resource is used.

RA=Rma+Rsl=2+0=2

The stored data is secured by a WORM system and an integrity check through hashing of the data files is provided.

RP=Rsp+Rdi=0+0=0

Only metadata is used for indexing the data files and the index is being updated in intervals of less than one hour.

RC=Rit+Riu=5+0=5

The risk associated with the above file is the sum of the above risk values

RS+RA+RP+RC=6+2+0+5=13

Assuming a file value Fv of 2 and a threshold value Et of 10, the file risk of mismanagement RF associated with the one particular file whose various risks are listed in the risk criteria table would be:

RF=(Fv)×(RS+RA+RP+RC)−Et=2×13−10=16

This is a positive value and indicates a relatively high risk of mismanagement associated with the particular file. A risk management decision may be made to discard this high risk copy or move the data to other device to make the risk lower. If the file value Fv was lower, for example Fv=1, then the risk value RF would be a lower value of 3 for this file. If the same process is repeated for several files including the specified file and its copies, then the final risk value RF may be positive for some files and negative for other files. Accordingly, the overall risk of mismanagement of information RI in all of the files of a copy group which is the sum of all RF values may be larger or smaller than the risk of mismanagement associated with one particular copy.

When a company owns multiple archives associated with multiple divisions, the archives may be consolidated into one archive storage system. However, the archive corresponding to each division must be managed according to the needs of that particular division. By utilizing the aspects of the present invention, various quality control criteria and measures may be implemented for divisions of the same one archive storage system and the archived data for each division may be managed in a manner corresponding to the requirements of that division.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

What is claimed is:

1. A method for evaluating and displaying risk of information mismanagement in a computer storage system, the method comprising:
obtaining a location of a specified file stored on the storage system;
searching for copies of the specified file in the storage system to obtain found copies;
obtaining a file risk of mismanagement value for each of the found copies; and
displaying the file risk of mismanagement values for each of the found copies.

2. The method of claim 1, further comprising:
obtaining a risk of mismanagement of information by adding together the file risk of mismanagement values for each of the found copies; and
displaying the risk of mismanagement of information and the file risk of mismanagement values for each of the found copies.

3. The method of claim 1, further comprising:
discarding the found copies having an associated file risk of mismanagement greater than a first value.

4. The method of claim 1, wherein obtaining a file risk of mismanagement value for each of the found copies comprises:
calculating component risks associated with the found copy;
retrieving a file value for the found copy;
retrieving an evaluation threshold;
adding together the component risks to obtain a file sum and weighing the file sum by the file value to obtain a weighted file sum; and
subtracting the evaluation threshold from the weighted file sum.

5. The method of claim 4, wherein calculating component risks comprises:
calculating a storage availability risk;
calculating a data accessibility risk;
calculating a data preservation risk; and
calculating a data searchability risk,
wherein the storage availability risk, the data accessibility risk, the data preservation risk, and the data searchability risk are associated with a storage unit of the storage system, the storage unit storing the found copies.

6. The method of claim 5, wherein calculating a storage availability risk comprises:
obtaining a system reliability risk;
obtaining a media reliability risk;
obtaining a current state risk; and
adding together the system reliability risk, the media reliability risk and the current state risk.

7. The method of claim 5, wherein calculating a data accessibility risk comprises:
obtaining a media accessibility risk;
obtaining a system loading risk; and
adding together the media accessibility risk and the system loading risk.

8. The method of claim 5, wherein calculating a data preservation risk comprises:
obtaining a protection risk;
obtaining a data integrity risk; and
adding together the protection risk and the data integrity risk.

9. The method of claim 5, wherein calculating a data searchability risk comprises:
obtaining an indexing type risk;
obtaining an indexing update interval risk; and
adding together the indexing type risk and the indexing update interval risk.

10. The method of claim 4, further comprising:
permitting modification of the evaluation threshold; and
permitting modification of elemental risk levels used in calculating the component risks.

11. A method for monitoring and managing a risk of mismanagement of information contained in files being stored in logical storage units of physical storage devices, the physical storage devices being coupled to a server, the method comprising:
receiving a request;
determining if the request is a device discovery request, a criteria management request, a data replication request, or a risk evaluation request;
extracting device management information from a requested physical storage device and storing the device management information in a configuration table at the server, responsive to the device discovery request asking for the requested physical storage device;
displaying first tables comprising a file value table, a risk criteria table, and an evaluation threshold table and updating values recorded in the first tables, responsive to a criteria management request;
managing copies of a specified file, responsive to a data replication request; and
evaluating an overall risk of mismanagement of information contained in the copies and displaying the overall risk of mismanagement of information responsive to a risk evaluation request.

12. The method of claim 11,
wherein the server stores a copy list table comprising copy groups, each copy group corresponding to a list of copies of each of the files, and
wherein the managing copies of a specified file comprises:
receiving a source location and a destination location for the specified file;
copying the specified file from the source location to the destination location;
searching the copy list table for a first copy group comprising the source location of the specified file;
adding the destination location to the copy group if the first copy group is found and does not comprise the destination location;
searching the copy list table for a second copy group comprising the destination location if the first copy group comprising the source location is not found;
adding the source location to the second copy group if the second copy group is found; and
creating a third copy group comprising the source location and the destination location if the first copy group and the second copy group are not found in the copy list table.

13. The method of claim 11, wherein evaluating an overall risk of mismanagement of information contained in the copies comprises:
receiving a source location of the specified file;
searching for the copies of the specified file;
calculating a file risk for each of the copies; and
calculating the overall risk of mismanagement of information by adding together the file risks.

14. The method of claim 13, wherein the calculating a file risk comprises:
calculating component risks from risk level values in the risk criteria table;
obtaining a sum risk by adding together the component risks;
weighing the sum risk by a corresponding file value in the file value table; and
obtaining the file risk by subtracting an evaluation threshold value in the evaluation threshold table from the sum risk,
wherein the risk level values correspond to a storage location of the copies.

15. The method of claim 14, wherein the component risks comprise at least one of a system reliability risk, a media reliability risk, a current state of data risk, a media accessibility risk, a system loading risk, a security risk, a data integrity risk, an indexing method risk and an index update interval risk.

16. A system for storing information and monitoring a risk of mismanagement of the information, the system comprising:
an administrator comprising:
a central processing unit;
a user interface; and
a memory; and
a storage system coupled to the administrator through a network,
wherein the storage system is adapted for storing data files, some of the data files being a copy of another data file, and
wherein the memory comprises parameters for calculating a file risk of mismanagement of each of the data files and for calculating the risk of mismanagement of the information contained in a specified data file and all copies of the specified data file.

17. The system of claim 16, wherein the storage system comprises:
physical storage devices comprising the data files and each comprising a corresponding physical storage device management information; and
a search engine for indexing the data files and comprising search engine management information,
wherein each of the physical storage devices comprises one or more logical storage units.

18. The system of claim 17, wherein the parameters are included in information tables residing in the memory, the information tables comprising at least one of:
a device definition table comprising first risk parameters for each of the physical storage devices;
a configuration table comprising second risk parameters for each of the logical storage units;
a copy list table comprising copy groups, each copy group corresponding to a list of copies of each of the data files;
a file value table providing a weight factor for each of the data files;
an elemental risk criteria table providing elemental risk levels corresponding to the first risk parameters and the second risk parameters;
an evaluation threshold table providing a threshold value for the file risk; and
a device address table comprising a location for each of the physical storage devices.

19. The system of claim 18,
wherein the elemental risk criteria table comprises risk categories comprising storage availability, data accessibility, data preservation, and data searchability,
wherein each of the risk categories comprises risk subcategories,
wherein the storage availability comprises the risk subcategories of system reliability, media reliability, and current state of the media,
wherein the data accessibility comprises the risk subcategories of media accessibility and system load,
wherein the data accessibility comprises the risk subcategories of security of file protection and data integrity, and
wherein the data searchability comprises the risk subcategories of indexing method and indexing update interval.

20. The system of claim 18, wherein the weight factors in the file value table, the elemental risk levels in the elemental risk criteria table, and the threshold value in the evaluation threshold table may be modified by a user of the system.
